(19) United States
(12) Patent Application Publication
(10) Pub. No.: US 2013/0054862 A1
(43) Pub. Date: Feb. 28, 2013

(54) STORAGE DEVICE HAVING COMMUNICATION FUNCTION AND EXPANDABLE MEMORY CAPACITY

(71) Applicant: Chia-Hsin Tsai, New Taipei City (TW)

(72) Inventor: Chia-Hsin Tsai, New Taipei City (TW)

(21) Appl. No.: 13/238,786

(22) Filed: Sep. 21, 2011

(30) Foreign Application Priority Data
Aug. 26, 2011 (TW) 100215999

(51) Int. Cl. G06F 13/00

(52) U.S. Cl. 710/301

(57) ABSTRACT

The present invention relates to a storage device having communication function and expandable memory capacity, which comprises: a top housing having a first open slot at one side; a bottom housing engaged with the top housing for forming an accommodating space; a printed circuit board; a terminal seat; a memory array; a memory controller; a processer; and a wireless communication module. When the storage device is inserted in a portable electronic device, data in the memory array can be transmitted to a remote mainframe through the wireless communication module. Moreover, the storage device has a slot allowing a removable memory card to be inserted for expanding the memory capacity of the storage device.

### BACKGROUND OF THE INVENTION

1. Field of the Invention

The present invention relates to a storage device, especially to a storage device having communication function and expandable memory capacity.

2. Description of Related Art

At present, there are many kinds of flash memory cards in the marketplace, wherein the SD memory card has the advantages of large storage capacity and lower purchase price. As such, a portable electronic device, e.g. a digital camera and digital camcorder, is often provided with a slot for SD memory card for the purpose of lowering the expenditure that consumers have to pay for memory cards.

Even though the SD memory card at the current marketplace has the advantages of large storage capacity and lower purchase price, the SD memory card can only be used to store data. When a user wants to upload the data stored in the SD memory card to a computer mainframe, the SD memory card has to be inserted into a digital camera, digital camcorder or card reader for uploading the data to the computer mainframe with a wired means. It is know that the mention operation is not convenient.

There is another kind of SD memory card which is built in with a wireless communication module. When a user wants to upload the data in the SD memory card to the computer mainframe, only an operation of inserting the SD memory card into a digital camera or digital camcorder has to be processed for uploading the data to the computer mainframe with a wireless means which is provided by the wireless communication module. So the operation is relatively easy and convenient. But the mentioned SD memory card having communication function is costly and once the capacity of built in memory is full, the capacity is not expandable, and the user has to purchase a new SD memory card having communication function. Therefore the user may have to spend more money for data storage.

In view of the disadvantages of conventional SD memory card, the present invention provides a storage device having communication function and expandable memory capacity for improving the mentioned disadvantages.

### SUMMARY OF THE INVENTION

One primary object of the present invention is to provide a storage device having communication function and expandable memory capacity, which is built in with a wireless communication module for uploading the data in a memory to a computer mainframe with a wireless means.

Another object of the present invention is to provide a storage device having communication function and expandable memory capacity, which is installed with a memory slot for allowing a removable memory card to be inserted for achieving an advantage of expanding memory capacity.

For achieving the mentioned objects, the present invention provides a storage device having communication function and expandable memory capacity, which comprises: a top housing having a first open slot at one side, the first open slot allows a removable memory card to be inserted; a bottom housing engaged with the top housing for forming an accommodation space, plural second open slots are formed at the top corresponding to the first open slot; a printed circuit board received in the accommodation space, and having a hollow part corresponding to the first open slot, and the rear side thereof has a plurality of first contact pads respectively exposed outside the plural second open slots; a terminal seat disposed on the printed circuit board, one end thereof has a plurality of second contact pads fastened on the printed circuit board, the other end thereof has a plurality of terminals extended to the hollow part; a memory array disposed on the printed circuit board for storing data; a memory controller disposed on the printed circuit board and coupled to the memory array and the removable memory card for controlling the access of the memory array and/or the removable memory card; a processor disposed on the printed circuit board and coupled to the memory controller; and a wireless communication module disposed on the printed circuit board and coupled to the processor for processing wireless communication; when the storage device is inserted in a portable electronic device, data in the memory array and/or the removable memory card can be transmitted to a remote mainframe through the wireless communication module.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a front exploded view illustrating the storage device having communication function and expandable memory capacity according to one preferred embodiment of the present invention;

FIG. 2 is a rear exploded view illustrating the storage device having communication function and expandable memory capacity according to one preferred embodiment of the present invention;

FIG. 3 is a schematic view illustrating the assembly of the storage device having communication function and expandable memory capacity according to one preferred embodiment of the present invention;

FIG. 4 is a block diagram illustrating the storage device having communication function and expandable memory capacity according to one preferred embodiment of the present invention; and

FIG. 5 is a schematic view illustrating the operation of the storage device having communication function and expandable memory capacity according to one preferred embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention

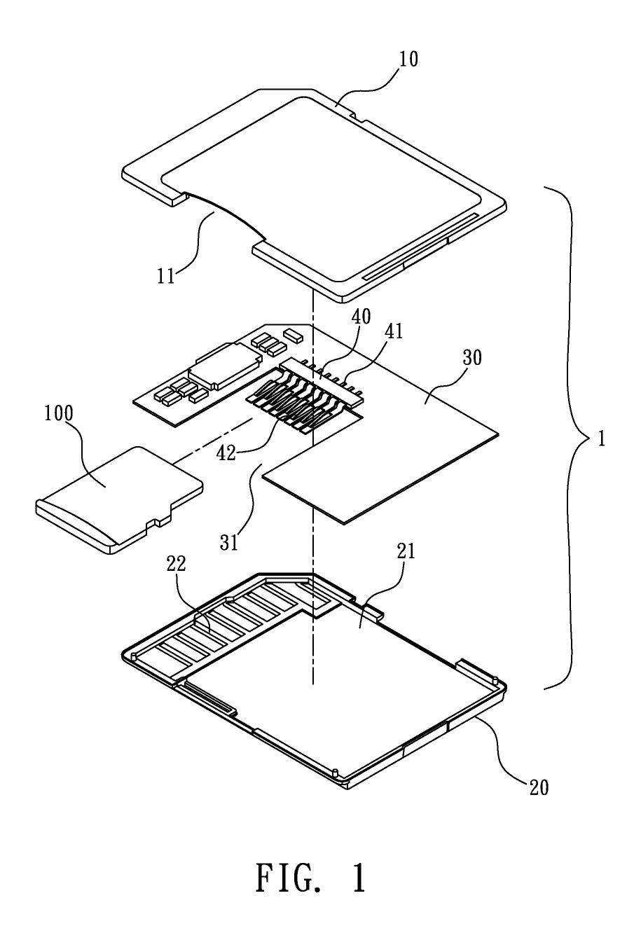

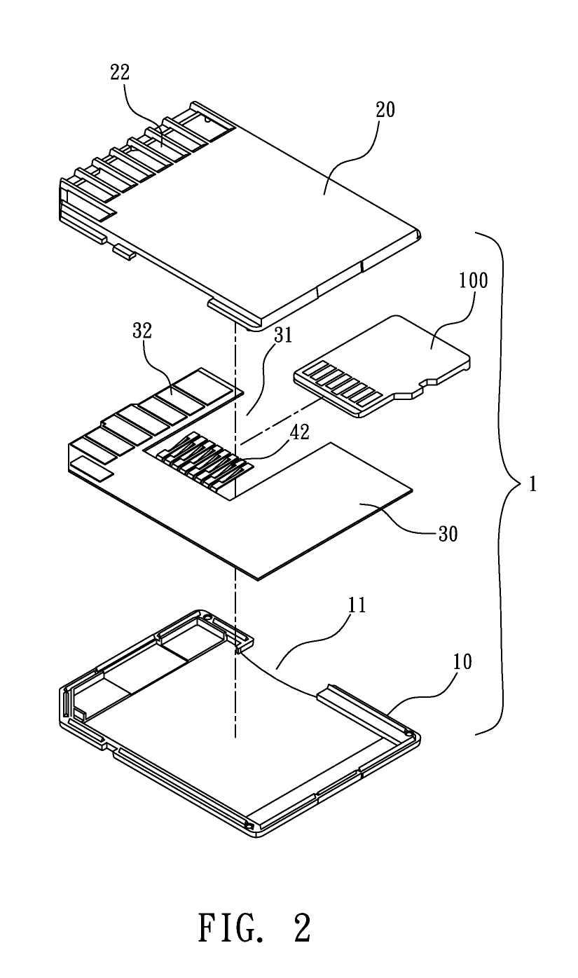

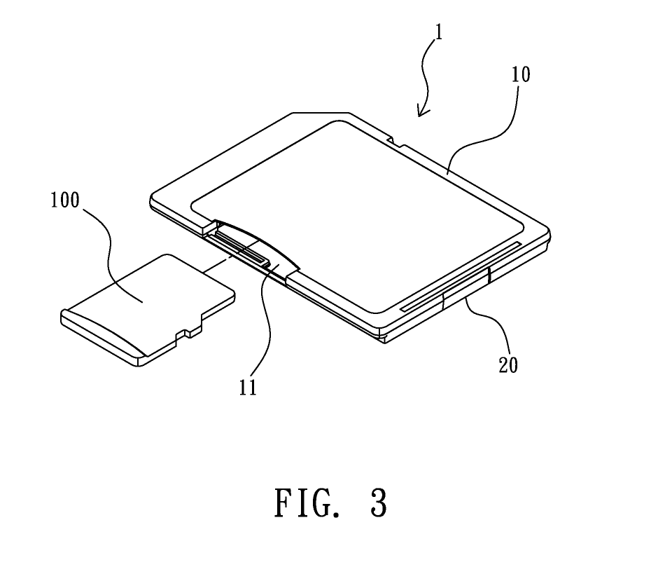

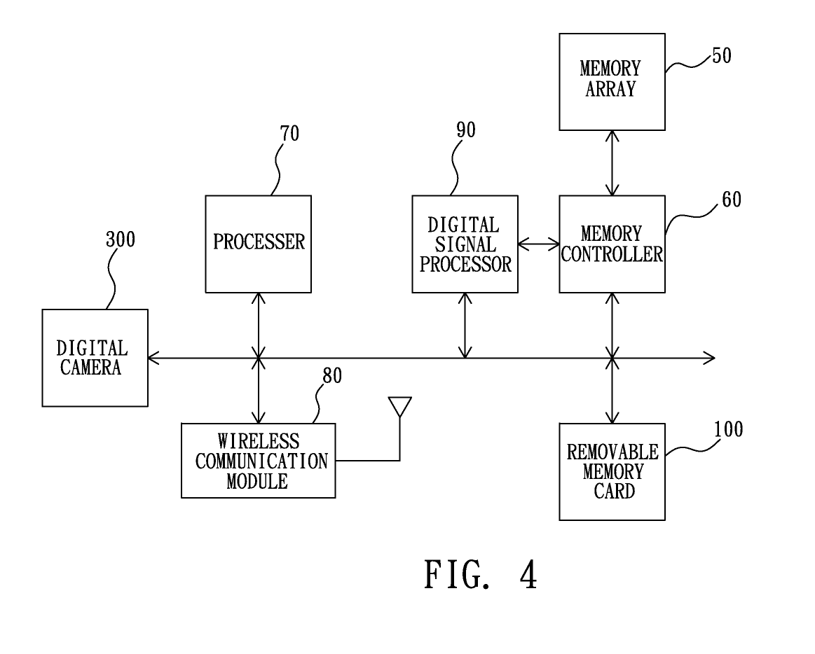

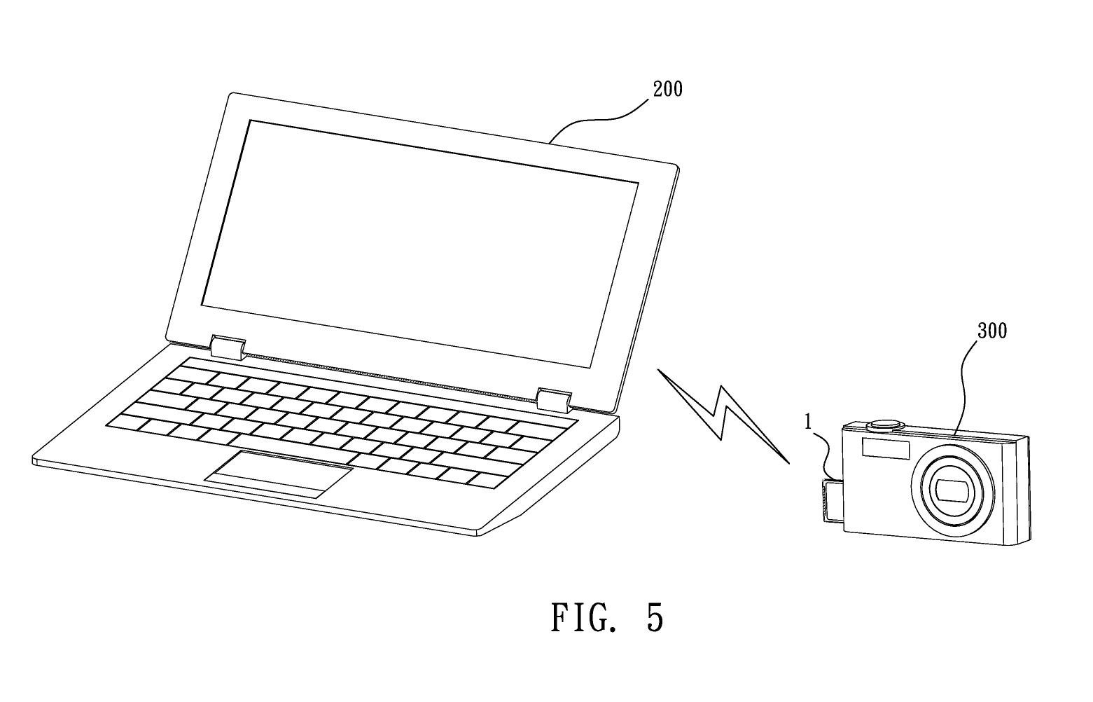

Please refer from FIG. 1 to FIG. 5, wherein FIG. 1 is a front exploded view showing the storage device having communication function and expandable memory capacity according to one preferred embodiment of the present invention; FIG. 2 is a rear exploded view showing the storage device having communication function and expandable memory capacity according to one preferred embodiment of the present invention; FIG. 3 is a schematic view showing the assembly of the storage device having communication function and expandable memory capacity according to one preferred embodiment of the present invention; FIG. 4 is a block diagram showing the storage device having communication function and expandable memory capacity according to one preferred embodiment of the present invention; and FIG. 5 is a schematic view showing the operation of the storage device having communication function and expandable memory capacity according to one preferred embodiment of the present invention.

As shown in figures, the storage device 1 having communication function and expandable memory capacity provided by the present invention comprises: a top housing 10, a bottom housing 20, a printed circuit board 30, a terminal seat 40, a memory array 50, a memory controller 60, a processer 70 and a wireless communication module 80.

The top housing 10 is made of an insulation material, e.g. but not limited to, plastic, and one side thereof, e.g. but not limited to the left side, is formed with a first open slot 11 allowing a removable memory card 100 to be inserted, wherein the removable memory card 100 is e.g. but not limited to a TF memory card.

The bottom housing 20 is made of an insulation material, e.g. but not limited to, plastic, and can be engaged with the top housing 10 for forming an accommodation space 21. The top of the bottom housing 20 is formed with plural second open slots 22 corresponding to the first open slot 11.

The printed circuit board 30 is disposed in the accommodation space 21, and formed with a hollow part 31 corresponding to the first open slot 11. The rear side of the printed circuit board 30 is formed with a plurality of first contact pads 32. The plural first contact pads 32 are allowed to be exposed outside the plural second open slots 22, wherein the first contact pad 32 are e.g. but not limited to the contact pads of SD memory card, mini SD memory card or CF memory card. In this embodiment, a SD memory card is adopted for illustration and shall not be defined as a limitation of the scope of the invention.

The terminal seat 40 is installed on the printed circuit board 30, one end thereof has a plurality of second contact pads 41 fastened on the printed circuit board 30, the other end thereof has a plurality of terminals 42 extended to the hollow part 31, wherein the plural terminals 42 are e.g. but not limited to terminals of TF memory cards for contacting the removable memory card 100.

The memory array 50 is disposed on the printed circuit board 30 for storing data, wherein the memory array 50 is e.g. but not limited to a flash memory array.

The memory controller 60 is disposed on the printed circuit board 30 and coupled to the memory array 50 and the removable memory card 100 for controlling the access of the memory array 50 and/or the removable memory card 100.

The processor 70 is disposed on the printed circuit board 30 and coupled to the memory controller 60 for controlling the operations of the memory controller 60 and the wireless communication module 80, wherein the processor 70 is e.g. but not limited to a micro processor.

The wireless communication module 80 is disposed on the printed circuit board 30 and coupled to the processor 70 for being controlled by the processor 70 to transmit the data in the memory array 50 and/or the removable memory card 100 to a mainframe 200 with a wireless communication means. The wireless communication module 80 is e.g. but not limited to a WIFI wires communication module or 3G wireless communication module, and the mainframe 200 is e.g. but not limited to a computer or cloud server.

Moreover, the storage device 1 provided by the present invention further includes a digital signal processor 90 which is disposed on the printed circuit board 30 and coupled to the memory array 50 or the removable memory card 100 for processing an image treatment to the data in the memory array 50 or the removable memory card 100 then uploading to the mainframe 200 with a streaming means.

As shown in FIG. 5, when taking photos or capturing images, the storage device 1 provided by the present invention can be inserted in a memory card slot (not shown) of a digital camera 300. The digital camera 300 can be used for taking photos, and the photos taken can be stored in the memory array 50; when the memory array 50 is full, a user can insert the removable memory card 100 into the first open slot 11, thereby achieving the object of expanding memory capacity. When the user wants to upload photos or videos, a program (not shown) in the digital camera 300 can be used by the user to actuate the processor 70, meanwhile the processer 70 actuates the wireless communication module 80 for uploading the photos or videos in the memory array 50 and the removable memory card 100 to the mainframe 200 with a wireless means. As such, the storage device 1 having communication function and expandable memory capacity provided by the present invention has advantages of having expandable memory capacity and lower purchase expenditure when being compared to a conventional SD memory card or SD memory card having communication function.

As what is disclosed above, the storage device having communication function and expandable memory capacity provided by the present invention is built in with a wireless communication module which can upload the data stored in a memory to a computer mainframe; and has a memory card slot allowing a removable memory card to be inserted, thereby being equipped with the advantage of expanding memory capacity.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A storage device having communication function and expandable memory capacity, comprising:
a top housing having a first open slot at one side, said first open slot allowing a removable memory card to be inserted;
a bottom housing engaged with said top housing for forming an accommodation space, plural second open slots being formed at the top corresponding to said first open slot;
a printed circuit board received in said accommodation space, and having a hollow part corresponding to said first open slot, and the rear side thereof having a plurality of first contact pads respectively exposed outside said plural second open slots;
a terminal seat disposed on said printed circuit board, one end thereof having a plurality of second contact pads fastened on said printed circuit board, the other end thereof having a plurality of terminals extended to said hollow part;
a memory array disposed on said printed circuit board for storing data;
a memory controller disposed on said printed circuit board and coupled to said memory array and said removable memory card for controlling the access of said memory array and/or said removable memory card;
a processor disposed on said printed circuit board and coupled to said memory controller; and
a wireless communication module disposed on said printed circuit board and coupled to said processor for processing wireless communication;
when said storage device being inserted in a portable electronic device, data in said memory array and/or said removable memory card being transmitted to a remote mainframe through said wireless communication module.

2. The storage device having communication function and expandable memory capacity as claimed in claim 1, wherein said storage device is a SD memory card, mini SD memory card or CF memory card.

3. The storage device having communication function and expandable memory capacity as claimed in claim 1, wherein said removable memory card is a TF memory card.

4. The storage device having communication function and expandable memory capacity as claimed in claim 1, wherein said first open slot is formed at the left side of said top housing.

5. The storage device having communication function and expandable memory capacity as claimed in claim 1, wherein said first contact pads are the contact pads of SD memory card, mini SD memory card or CF memory card.

6. The storage device having communication function and expandable memory capacity as claimed in claim 1, wherein said second contact pad is the contact pad of TF memory card.

7. The storage device having communication function and expandable memory capacity as claimed in claim 1, further including a digital signal processor which is disposed on said printed circuit board and coupled to said memory array or said removable memory card for processing an image treatment to the data in said memory array or said removable memory card then uploading to said mainframe with a streaming means.

8. The storage device having communication function and expandable memory capacity as claimed in claim 1, wherein said mainframe is a computer or cloud server.

9. The storage device having communication function and expandable memory capacity as claimed in claim 1, wherein said wireless communication module is a WIFI wireless communication module or 3G wireless communication module.
